(19) United States
(12) Patent Application Publication
(10) Pub. No.: US 2005/0262054 A1
(43) Pub. Date: Nov. 24, 2005

(54) Item type specific structured search

(75) Inventor: Mikko Nurmi, Tampere (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/848,534

(22) Filed: May 18, 2004

(51) Int. Cl. G06F 7/00

(52) U.S. Cl. 707/3

(57) ABSTRACT

The invention discloses a method, a system, a device and a computer program for exploring items from an electronic storage. Items are organized in collections in the electronic storage. According to the invention a collection selection parameter may be determined. The parameter determines how the search results are presented to a user. The contents of at least one collection of the electronic storage are searched and collections comprising at least one item of the determined item type according to the collection selection parameter are chosen. Finally, the chosen collections are presented to the user.

### FIELD OF THE INVENTION

The invention relates to data management and especially searching items in an electronic system.

### BACKGROUND OF THE INVENTION

After recordable disks were introduced to computer technology there was a need for organizing stored files. This was satisfied with developing a structured file system to which files were stored. The File Allocation Table (FAT) system is a traditional example of such a system. Storage space may be organized so that there is a tree of directories that may have one or more sub-directories. A user of a computer chooses how to store and organize the files in the file system. Traditionally files have been organized in directories and the type of the file can be recognized from the extension of the file name, for example, .doc, .pdf, .txt etc. Recently the amount of data and the number of the files has grown massively. Thus, it is difficult to search specific files from the file system having a large number of directories and sub-directories. Especially it is cumbersome to present the search results in one view.

Earlier this problem has been solved e.g. by searching the files in a file system. There are several possibilities to perform a search with selected criteria. Typical example is that a user enters the criteria and then a searching agent traverses through the file system. Afterwards the search result is displayed as a list of files. The list is constructed so that the files are in the same list even if they are actually located in different directories. This solution can be enhanced with database technology where the file system information is stored on a database. Thus, it is not necessary to traverse through the whole file system as the required information is maintained on the database. The drawback of this solution is that there may be too many files in the results list since there may be a huge amount of files stored on the disk. For example, a graphic designer might want to search the image files from a hard disk and the result may consist of thousands of matches.

To avoid this problem a user may restrict the searching criteria. However, it is very difficult to do so, if the user does not remember other characteristics than, for example, the file type. This could be solved so that files have further characteristics that can be used as searching criteria. This kind of system is disclosed in U.S. Pat. No. 5,544,360, in which the user may define further categories for files while storing them. The drawback of this system is that the user needs to enter a lot of data into the system.

Within one directory the problem has been solved so that application programs typically show only files that they are able to use. For example, a graphics program usually displays file names of all types of image files that it is able to read and display. The drawback of this solution is that desired files may be stored in different directories. Therefore, they are hard to find especially because typically there is no searching function in the open file dialog. Thus, the user might end up having to browse a plurality of directories even if they might not contain image files at all.

### SUMMARY OF THE INVENTION

The invention discloses a method, a device, a computer program, a computer program product and a system for effectively exploring and presenting items from a storage media. The storage media is equipped with a file system that allows hierarchical storage of items. The media can be, for example, a hard disk of a computer or a flash memory used in a mobile device.

According to a method of the invention at least one item type to be searched is determined. The determination can be made e.g. by a user or it may be a feature of a software application. Furthermore, a collection selection parameter is determined. The collection selection parameter refers to a parameter that defines which collections will be displayed to the user in the end.

A method according to the invention explores at least a part of a file system and chooses collections comprising at least one item of the determined item type according to the collection selection parameter. The chosen collections are presented to the user.

In one embodiment of the invention if a collection itself does not contain items of determined item type but its sub-collections do, the higher-level collection can be omitted from the presentation.

As for further characteristics of the invention reference is made to the detailed description below.

The invention allows easy access to items that are stored in several places in a file system. A further benefit of the invention is that a user is able to see collections that are relevant in view of a certain search.

A further benefit of the invention is that it is possible to retain a hierarchic collection structure. Thus, the user does not lose the meta information coded into a name or structure of a collection, for example, the name of the collection might indicate that the pictures of the collection are, for example, from a summer vacation.

### BRIEF DESCRIPTION OF THE DRAWINGS

The accompanying drawings, which are included to provide a further understanding of the invention and constitute a part of this specification, illustrate possible embodiments of the invention and together with the description help to explain the principles of the invention. In the drawings:

FIG. 1 is a flow chart of a method according to one embodiment of the invention;

FIG. 2 is a block diagram of one embodiment of a device of the invention; and

FIGS. 3-8 are example views of some embodiments of the invention.

### DETAILED DESCRIPTION OF THE INVENTION

Reference will now be made in detail to possible embodiments of the present invention, examples of which are illustrated in the accompanying drawings. In the following examples items to be searched from collections are assumed to be files stored in directories of a file system.

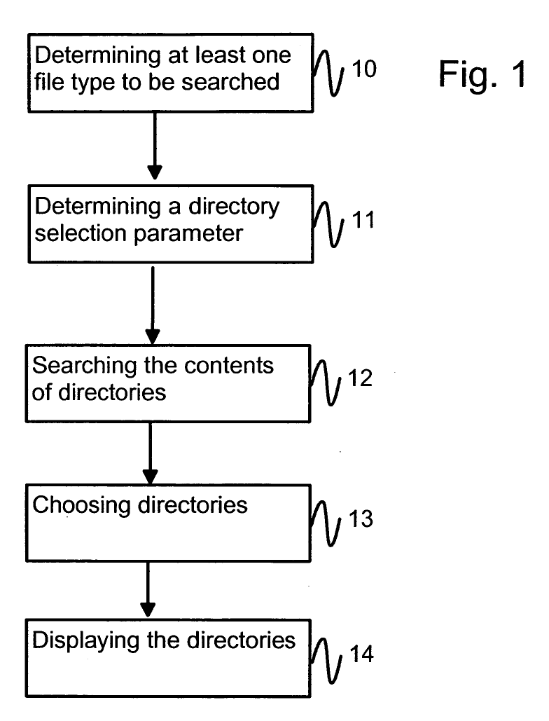

FIG. 1 is a flow chart representing a method according to one embodiment of the invention. In the embodiment a user of a computer, a mobile terminal or other similar device capable of storing files searches particular files, e.g. image files from a file system of the device. The steps shown in FIG. 1 may be embodied in a computer program stored on a computer readable medium which may constitute a computer program product. The steps may be carried out within a single entity such as a personal computer, personal digital assistant, cellphone, or any other entity. On the other hand, selected steps may be carried out in different entities in communication with each other over a network. One or more data structures for carrying out the illustrated steps may be transmitted over the network and at least temporarily stored in a computer readable medium in both sending entity and a receiving entity. For instance, one entity might be a server for storing and organizing the information and the other entity might be a client in communication with the server over a network. A data structure used in the communication might include a plurality of predefined primitives, each primitive for at least temporary storage in a computer-readable medium at the client and in a computer readable medium at the server during transfer of said primitives on a carrier wave over a network, whether wired or wireless or some combination thereof, between the client and the server. The characteristics of the primitives would depend on the particular data management application and search tools. Thus the data structure would include various primitives that could be provided from a client of a requesting user to a server to request searched information available at the server using tools understood by both the client and the server. The primitives would have various information elements including elements appropriate to accessing information made available by the management structure. The results obtained by the server in response to the client search would also comprise a data structure with predefined primitives provided from the server to the requesting user client to provide the queried information.

At step 10 at least one file type to be searched is determined. The file type may be determined e.g. by a user or an application program. For example, if the user is using a graphics program and decides to open a file, it is possible that the program chooses the file type or file types to be searched. At step 11 a directory selection parameter is determined. The parameter defines how the selection of directories is shown in the final result to the user. In one embodiment if the directory selection parameter is not defined a default parameter may be used.

The user may refine searching parameters. A refinement may be, for example, that the chosen file type comprises several sub-types that include further characteristics. For example, a file type comprising image files may comprise images of several different file formats. The user may refine the search by selecting one or more file formats to be searched within a file type. In addition to a file format, the further characteristics may include various types of information attached to files, for example, image files may comprise the name of the source device, such as a brand of a digital camera, time and/or date of snapping, or other information relating to an image. A file type may be freely chosen, for example, from a list of available file types. Detailed search criteria as such are not crucial for the invention and they can be chosen freely.

After determining the searching criteria, e.g. the file type, the search is carried out in the file system, step 12. It is naturally possible to target the search only to a portion of a hard disk or to a system comprising several hard disks. Searching can be performed by traversing the directories and/or by using a database functionality. Directories comprising files of desired file type are modified for presentation according to the directory selection parameter, as indicated at step 13.

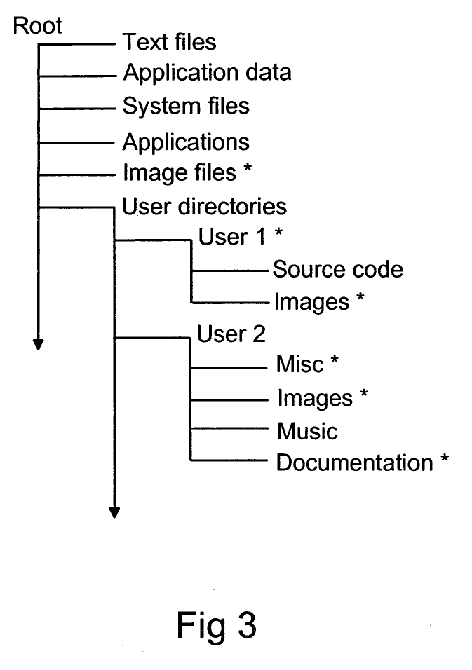

As a result the chosen directories are displayed to the user, as indicated at step 14. It is also possible to replace the step of displaying with some other operation. For example, the search results may be sent by e-mail to some other person or entity or they may be modified somehow. Displaying may be done, for example, in a form of a file manager in which the directory tree comprises directories that have files of the desired file type. Naturally also directories including sub-directories with files of the determined file type can be presented. There are many possibilities for presenting the directories. They may be arranged so that directories that do not have files of the desired file types are shown, but with a different color or highlighted or otherwise “marked” or indicated. It is also possible to use the method in a manner where the directories containing files of determined file type are marked or indicated, for example, with bolded font. Furthermore, it is also possible that a directory not containing a determined file type is not accessible, but it is not obligatory. One possibility is that a directory that does not itself comprise files of a desired file type but only sub-directories with files of the desired file type are visible. This type of higher-level directory can be shown as a normal directory or jumped over to one or more actual directories comprising files of the desired file type. It is also possible to present the contents of a directory, if it is the only directory comprising files of a desired file type. Thus, there is no need to traverse through the whole directory tree but it is possible to go directly to directories that comprise files of the desired file type. The user may choose freely the options how the results are displayed. Example views of different result listings are disclosed in FIGS. 3-8. Result listings may be only informative listings but in the examples the result listing is a fully functional view with access to the file system. Thus, if the user chooses a directory from the result listing, the content of the directory is displayed in accordance with the present search.

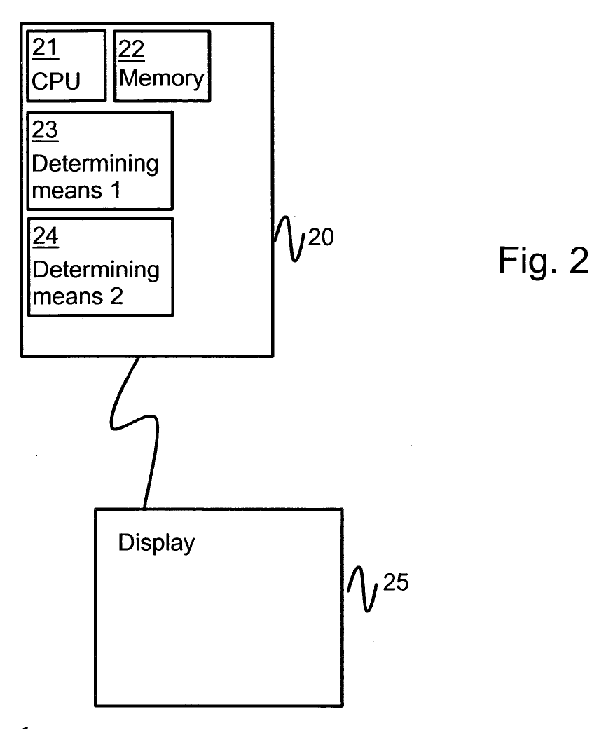

FIG. 2 discloses a block diagram of an example device according to the invention. The device 20 may be a computer, a mobile device, or other device that is equipped with a central processing unit 21 and a memory 22. Memory 22 has a file system comprising directories. The device 20 further comprises means 23 for determining a desired file type and means 24 for determining a directory selection parameter. The central processing unit 21 is configured to search the contents of at least one directory of the file system and to choose directories comprising at least one file of the determined file type according to the directory selection parameter. The search is performed for example by traversing directories or by additional database means that are not presented FIG. 2. In one embodiment of the invention the device is connected to a server, which comprises shared file systems to be searched. The server may be any type of server, for example a file server in a public network or a local area file server.

Searching results are displayed on a display 25. In FIG. 2 display 24 is an external display but it may also be included in the device 20. If the terminal device does not have a display or the user is not willing to use the display, it is also possible to present results by other means. For example, it is possible to send the result to other terminal or to present results by sound.

It will be evident to any person skilled in the art that means for determining 23 a file type and means for determining 24 a directory selection parameter may be implemented using hardware and/or software components.

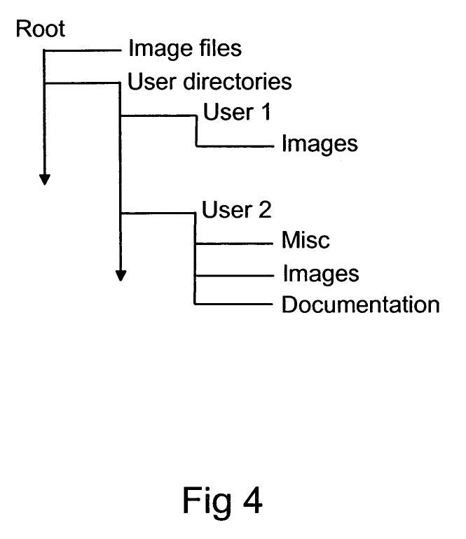

FIG. 3 discloses an expanded view of a file system to be searched according to one embodiment of the invention. In this case, the search is performed for image files according to the method described above. The tree can be presented to a user in several different ways, for example, in a form of a directory tree or in a form of a file manager that presents contents of a directory. In FIG. 3 the directories comprising image files are marked with “*”. FIG. 4 discloses a search result in which only directories comprising files of the determined at least one file type are displayed. In FIG. 4 the directories are displayed also in that case that they do not comprise files themselves but they comprise sub-directories that comprise files of the determined at least one file type. It is possible to show the directories according to FIG. 4, where “Image files” and “User directories” are presented since they belong to the same level in the hierarchy. The user may further browse the directories.

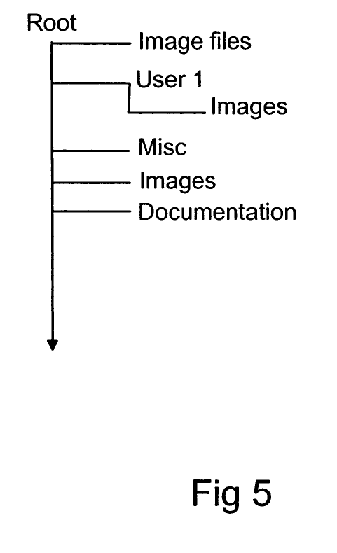

FIG. 5 discloses a search result in which only directories comprising files of the determined at least one file type are displayed. The difference between FIGS. 4 and 5 is that in FIG. 4 the original hierarchy of directories is maintained but in the view of FIG. 5 unnecessary directories are removed.

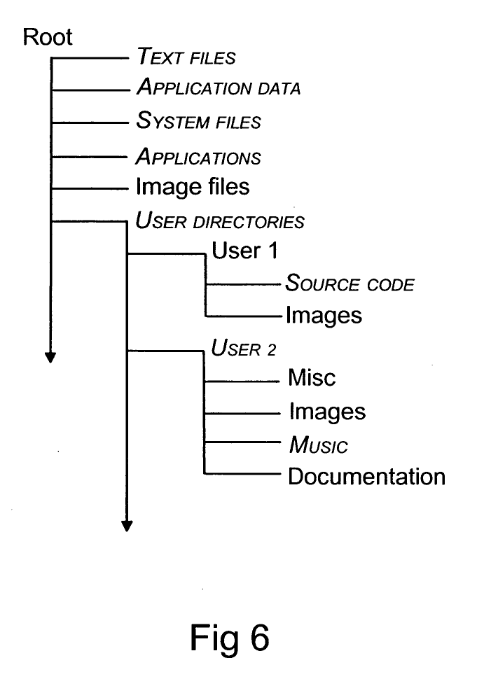

FIG. 6 discloses a search result in which all directories are shown. Directories and sub-directories that do not comprise files of the determined file type are marked with capital letters in italics. These directories may be marked also with some other type of differentiation, e.g. highlight, dimmed font, etc. It is also possible to make these directories inaccessible. However, this can also be carried out the other way round. For example, it is also possible to mark or somehow indicate the directories that do contain files of the determined file type.

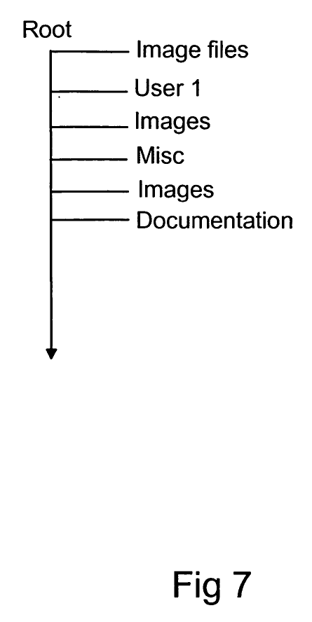

FIG. 7 discloses a search result in which the directories with files of the determined file type are shown as a list of directories that does not include the hierarchical dependencies of a directory tree. The directories are shown as if they were direct sub-directories of the root directory.

As a summary regarding FIGS. 3-7 the differences between the views of FIGS. 3-7 are due to the directory selection parameter. A default value of the directory selection parameter may be determined e.g. by a user or application.

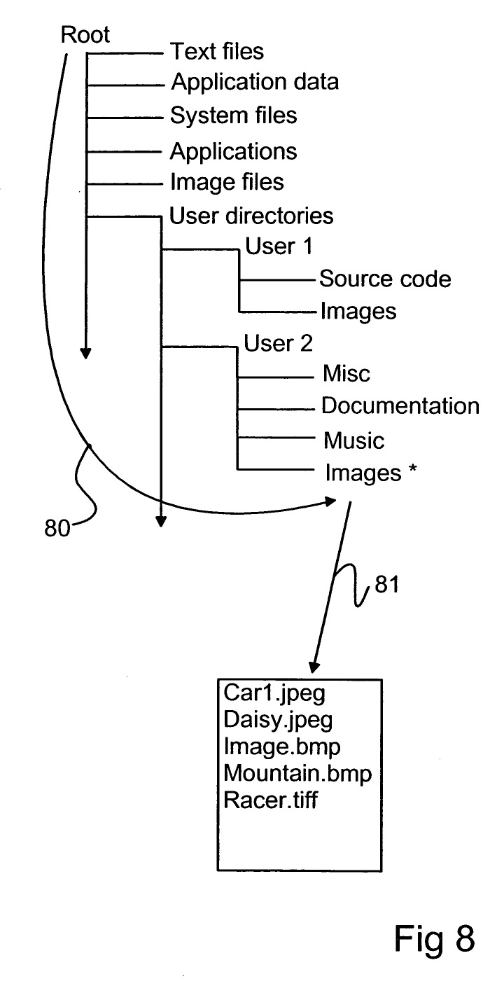

FIG. 8 discloses a search result in which only one directory comprises files of the selected file type. The method according to the invention jumps directly to the directory, as indicated by arrow 80. In FIG. 8 a simple view of file listing is produced from the contents of the directory, as indicated by arrow 81. It is obviously possible to include more information into the listing, for example, date of the file, and size of the file or a description of the file.

It will be evident to any person skilled in the art that the visualization of the result view may be customized to the user. For example, the names of the directories may be extended with further information. It is possible to attach for example information about more detailed characteristics within the file type. In case of image search this could mean, for example, that the name of the directory is extended with information on different file formats in the directory. This extended information may be in form of text or image or sound or any combination of them. Furthermore, the extended information may comprise information about the content of image files.

In a further embodiment of FIGS. 3-8 a user may be provided with further information based on a search. In one embodiment the name of a directory may be amended to comprise which file formats the directory comprises. For example, a directory “Summer pictures” may be amended into a form of “Summer pictures (.jpg, .gif)”. In another embodiment the further information refers to a picture symbol that relates to the actual directory name or to any other form of further information.

It will be evident to any person skilled in the art that with the advancement of technology, the basic idea of the invention may be implemented in various ways. The invention and its embodiments are thus not limited to the examples described above; instead they may vary within the scope of the claims.

1. A method for exploring an electronic system comprising at least one collection of one or more items, wherein the method comprises:
determining at least one item type to be searched;
exploring at least partially the contents of at least one collection of one or more items; and
choosing at least one collection comprising at least one item of the determined type.

2. A method according to claim 1, wherein the method further comprises:
determining a collection selection parameter.

3. A method according to claim 1, wherein the method further comprises:
presenting at least one of the chosen collections.

4. A method according to claim 1, wherein a collection comprising and a collection not comprising an item of the determined at least one item type are presented in different ways.

5. A method according to claim 1, wherein a collection of one or more items is not presented if it does not contain an item of the determined at least one item type.

6. A method according to claim 1, wherein the determined item type comprises one or more different formats.

7. A method according to claim 1, wherein a refinement exploration in a chosen collection of items with a further criterion is made.

8. A method according to claim 1, wherein the item type is chosen from a list of available criteria.

9. A computer program embodied in a computer readable medium or on a carrier wave with instructions operable to cause a processor to perform the method steps of claim 1.

10. A computer program according to claim 9 wherein the computer program is further arranged to perform a step of determining a collection selection parameter.

11. A computer program according to claim 9 wherein the computer program is further arranged to perform a step of presenting at least one of the chosen collections.

12. A computer program product comprising a computer program embodied in a computer readable medium or on a carrier wave with instructions operable to cause a processor to perform the method steps of claim 1.

13. A computer program product according to claim 12 wherein the computer program is further arranged to perform a step of determining a collection selection parameter.

14. A computer program product according to claim 12 wherein the computer program is further arranged to perform a step of presenting at least one of the chosen collections.

15. A device for exploring an electronic system wherein the device comprises:
a memory comprising a collection of one or more items;
a means for exploring at least a part of the memory;
first determining means for determining at least one item type to be searched; wherein
the means for exploring at least a part of the memory are configured to explore at least partially the contents of at least one collection of one or more items and to choose at least one collection comprising at least one item of the determined at least one item type.

16. A device according to claim 15, wherein the device further comprises a means to present at least one chosen collection.

17. A device according to claim 15, wherein the device further comprises second determining means for determining a collection selection parameter.

18. A device according to claim 15, wherein the device is one of the following: a mobile terminal, an integrated mobile communication and computing device, a personal digital assistant or a computer.

19. A system for exploring an electronic system wherein the system comprises:
a memory comprising a collection of one or more items;
a means for exploring at least a part of the memory;
first determining means for determining at least one item type to be searched; wherein
the means for exploring at least a part of the memory is configured to explore at least partially the contents of at least one collection of one or more items and to choose at least one collection comprising at least one item of the determined at least one item type.

20. A system according to claim 19, wherein the system further comprises a means to present chosen collections.

21. A system according to claim 19, wherein the system further comprises second determining means (24) for determining a collection selection parameter.

22. A system according to claim 19, wherein the memory is an external memory.

23. A data structure for at least temporary storage in computer-readable media at a pair of entities communicating over a network during transfer of said data structure over said network between the entities for carrying out the steps of claim 1.
